(19) United States
(12) Patent Application Publication
(10) Pub. No.: US 2003/0179329 A1
(43) Pub. Date: Sep. 25, 2003

(54) Array substrate for a reflective liquid crystal display device and fabricating method thereof

(76) Inventor: Su-Seok Choi, Gyeonggi-do (KR)

Correspondence Address: MCKENNA LONG & ALDRIDGE LLP, 1900 K STREET, NW, WASHINGTON, DC, 20006, US

(21) Appl. No.: 10/253,614

(22) Filed: Sep. 25, 2002

(30) Foreign Application Priority Data
Mar. 19, 2002 (KR) 2002-14810

(51) Int. Cl. G02F 1/1335

(52) U.S. Cl. 349/113

(57) ABSTRACT

An array substrate for a reflective liquid crystal display device includes a substrate; a first organic layer on the substrate, the first organic layer having a plurality of organic patterns of uneven shape, the plurality of organic patterns having at least two heights and at least two radii, a ratio of the height to the radius of each organic pattern having a range of values; and a reflective plate on the first organic layer, the reflective plate having a high reflectance.

This application claims the benefit of Korean Patent Application No. 2002-14810, filed on Mar. 19, 2002, which is hereby incorporated by reference for all purposes as if fully set forth herein.

### BACKGROUND OF THE INVENTION

1. Field of the Invention

The present invention relates to a liquid crystal display (LCD) device, and more particularly to a reflective LCD device including a reflective electrode of an uneven shape.

2. Discussion of the Related Art

Generally, LCD devices are classified according to a method of using a light source into transmissive LCD devices using a backlight and reflective LCD devices using an external light source. The transmissive LCD devices use a backlight, which consumes more than two thirds of the total power. On the other hand, since the reflective LCD devices do not use a backlight, power consumption is reduced. However, since the reflective LCD devices do not have a sufficient brightness, the contrast ratio is low and the color quality is not good. Improvement of an LCD cell structure, a reflective electrode and an optical filter, and development of new materials are necessary to increase brightness.

Since the conventional reflective electrode has a flat surface, light is reflected as if the reflective electrode is a mirror. This phenomenon is referred to as a mirror reflection. Therefore, the brightness is high only along any reflection direction depending on Snell's Law of Refraction. When incident light is reflected on a reflective display according to a position of a light source, the brightness is low along a normal direction of an LCD device. Another phenomenon that occurs is the light glare effect. This happens when a high-intensity external light source is reflected on a liquid crystal display panel. The displayed image is poor due to the glare that occurs as viewed by an observer due to the reflection of light. To increase the brightness along the normal direction and decrease the light glare effect on an LCD device, a reflective electrode of an uneven shape is suggested.

FIG. 1 is a schematic cross-sectional view of a conventional reflective liquid crystal display device using a reflective electrode of an uneven shape.

In FIG. 1, upper and lower substrates 24 and 6 are spaced apart from each other, and a liquid crystal layer 20 is interposed therebetween. A black matrix 21 and a color filter layer 22a, 22b and 22c are formed on an inner surface of the upper substrate 24. A common electrode 23 of a transparent conductive material is formed on the color filter layer 22a, 22b and 22c. A thin film transistor (TFT) “T” and a data line 17 are formed on an inner surface of the lower substrate 6. A reflective electrode 18 of a metallic material having a high reflectance is formed on an passivation layer 16 of an organic material that is formed on the TFT “T.” The TFT “T” includes a gate electrode 8, a gate insulating layer 10, an active layer 12, an ohmic contact layer 13, and source and drain electrodes 14 and 15. The passivation layer 16 and the reflective electrode 18 have an uneven shape to obtain a high brightness by enlarging a scattering area of the light in the reflective LCD device. However, it is difficult to increase a brightness of a reflective LCD device even using a reflective electrode of an uneven shape due to a smaller effective scattering area of the light on the surface of the substrate.

FIG. 2 is a schematic cross-sectional view of a conventional reflective liquid crystal display device using a reflective electrode and a front scattering film.

In FIG. 2, a liquid crystal layer 20 is interposed between upper and lower substrates 24 and 6. A TFT “T” and a data line 17 are formed on an inner surface of the lower substrate 6. The TFT “T” includes a gate electrode 8, a gate insulating layer 10, an active layer 12, an ohmic contact layer 13, and source and drain electrodes 14 and 15. An organic insulating layer 16 having a flat surface is formed on the TFT “T” and the data line 17. A reflective electrode 18 is formed on the organic insulating layer 16. A front scattering film 25 is formed on an outer surface of the upper substrate 24 to enlarge a scattering area of the reflected light. However, an image-blurring phenomenon due to back scattering of the front scattering film 25 degrades a display quality of the reflective LCD device.

During operation of the device, incident light generally enters an upper substrate at about a 30° angle with respect to a normal direction of the upper substrate. The incident light passes through the liquid crystal layer and is reflected at the reflective electrode. Then, the reflected light is emitted through the upper substrate and is perceived by users. Taking into consideration that a main viewing angle is generally within a range of about 0° to about 10°, the incident light should be reflected at an angle within a range of about 0° to about 10° to obtain high brightness and high efficiency of the reflective LCD device.

FIG. 3A is a schematic cross-sectional view showing a path of incident light in a conventional reflective liquid crystal display device. FIG. 3B is a schematic magnified cross-sectional view of a portion “A” of FIG. 3A.

In FIG. 3A, light “L1” in air 38 enters an upper substrate 36 with an incidence angle “α” of about 30° with respect to a normal direction of the upper substrate 36. The light “L1” is refracted and becomes light “L2” with a refraction angle “β” of about 20° with respect to the normal direction of the upper substrate 36 according to Snell's Law of Refraction. The refracted light “L2” passes through a liquid crystal layer 34 and is reflected by reflective electrode 32. A slanting angle “θ” due to an unevenness of the reflective electrode 32 may be adjusted to be within a range of about 6° to about 10° so that reflected light “L3” can be transmitted within a main viewing angle “γ.” A slanting angle may be defined by the following formula: θ=tan⁻¹(H/R), where H is the height of the uneven shape and R is the radius of the uneven shape. The slanting angle due to the unevenness may be adjusted during a fabricating process of a reflective electrode having an unevenness.

In FIG. 3B, the slanting angle “θ” of each reflective electrode 32 is determined by a height “H” and a radius “R” of each electrode 32.

FIGS. 4A and 4B are schematic cross-sectional views showing a first conventional method of fabricating an organic layer having an unevenness.

In FIG. 4A, an organic layer 42 including organic patterns 42a is formed on a substrate 40. The organic patterns are overlapped or spaced by coating and patterning the organic material. Since a space between the organic patterns 42a is adjustable, the organic patterns 42a can be overlapped or spaced.

In FIG. 4B, the organic patterns 42a (of FIG. 4A) melt by a heat treatment and a straight sidewall of each organic pattern becomes round. The melted organic patterns 43a become hard by a curing process.

In the first method, it is most important to adjust the organic patterns of the straight sidewall to have a desired slanting angle by the heat treatment. It is difficult to obtain a larger scattering area and to control the slanting angle.

FIGS. 5A to 5C are schematic cross-sectional views showing a second conventional method of fabricating an organic layer having an unevenness.

In FIG. 5A, a first organic layer 52 including organic patterns 52a is formed on a substrate 40 and the organic patterns 52a are spaced apart from each other.

In FIG. 5B, a sidewall of each organic pattern 53a becomes round by a heat treatment.

In FIG. 5C, a slanting angle “θ” is adjusted by forming a second organic layer 54 on the round organic patterns 53a.

In the second method, it is most important to obtain a desirable slanting angle by forming the organic patterns 52a to be spaced and adjusting a thickness of the second organic layer 54.

FIG. 6A is a schematic plan view of a first conventional photo mask.

In FIG. 6A, a first conventional photo mask includes a transmissive portion 60 and a shielding portion 61 arbitrarily disposed to increase a scattering area.

FIG. 6B is a schematic cross-sectional view of an organic layer formed by using the first conventional photo mask. FIG. 6C is a schematic magnified cross-sectional view of a portion “B” of FIG. 6B.

In FIG. 6B, after an organic layer 62 is patterned on a substrate 63 by using the first conventional photo mask, the organic layer 62 including organic patterns 62a is heat-treated. Each organic pattern 62a has a slanting angle “θ.”

In FIG. 6C, the slanting angle “θ” of each organic pattern 62a is determined by a height “H” and a radius “R” of each organic pattern 62a.

FIG. 7A is a schematic plan view of a second conventional photo mask.

In FIG. 7A, a second conventional photo mask includes a transmissive portion 70, first and second shielding portions 71 and 72. The second shielding portion 72 is disposed between the adjacent first shielding portions 71 to increase a scattering area. That is, a space between the adjacent first shielding portions 71 is filled with the second shielding portion 72 to increase a packing density and a scattering area density.

FIG. 7B is a schematic cross-sectional view of an organic layer formed by using a second conventional photo mask. FIG. 7C is a schematic magnified cross-sectional view of a portion “C” of FIG. 7B.

In FIG. 7B, an organic layer 73 is patterned on a substrate 75 by using the second conventional photo mask. The organic layer 73 includes first and second organic patterns 73a and 73b respectively having first and second slanting angles “θ₁” and “θ₂.”

In FIG. 7C, even though a height “H” of the first organic pattern 73a is the same as that of the second organic pattern 73b, a radius “R” of the first organic pattern 73a is longer than that “r” of the second organic pattern 73b. Accordingly, the first slanting angle “θ₁” is less than the second slanting angle “θ₂.” Since light reflected at the second organic pattern 73b is out of the main viewing angle due to back scattering resulting from the larger second slanting angle “θ₂,” light within the main viewing angle does not increase. That is, even though the organic patterns and the scattering area density increase, organic patterns having an effective slanting angle in the direction of the observer are not sufficient to increase reflected light within the main viewing angle.

Since the organic patterns are formed by deposition and exposure, the organic patterns having at least two heights cannot be formed by one step of deposition and exposure. Accordingly, at least two steps of deposition, exposure, development and cure are necessary to form the organic patterns having at least two heights and to increase the organic patterns having an effective slanting angle.

### SUMMARY OF THE INVENTION

Accordingly, the present invention is directed to a liquid crystal display device that substantially obviates one or more of problems due to limitations and disadvantages of the related art.

An advantage of the present invention is to provide a reflective liquid crystal display device having a high brightness by adjusting a slanting angle within a range of values in the direction of an observer.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an array substrate for a reflective liquid crystal display device includes: a substrate; a first organic layer on the substrate, the first organic layer having a plurality of organic patterns of uneven shape, the plurality of organic patterns having at least two heights and at least two radii, a ratio of a height to a radius of each organic pattern having a range of values; and a reflective plate on the first organic layer, the reflective plate having a high reflectance.

In another aspect of the present invention, a fabricating method of an array substrate for a reflective liquid crystal display device includes: forming a first organic layer on a substrate, the first organic layer having a plurality of organic patterns of uneven shape, the plurality of organic patterns having at least two heights and at least two radii, a ratio of the height to the radius of each organic pattern having a range of values; heating the first organic layer; and forming a reflective plate on the first organic layer, the reflective plate having a high reflectance.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic cross-sectional view of a related art reflective liquid crystal display device using a reflective electrode of an uneven shape;

FIG. 2 is a schematic cross-sectional view of a related art reflective liquid crystal display device using a reflective electrode and a front scattering film;

FIG. 3A is a schematic cross-sectional view showing a path of incident light in a related art reflective liquid crystal display device;

FIG. 3B is a schematic magnified cross-sectional view of a portion “A” of FIG. 3A;

FIGS. 4A and 4B are schematic cross-sectional views showing a first related art method of fabricating an organic layer having an unevenness;

FIGS. 5A to 5C are schematic cross-sectional views showing a second related art method of fabricating an organic layer having an unevenness;

FIG. 6A is a schematic plan view of a first related art photo mask;

FIG. 6B is a schematic cross-sectional view of an organic layer formed by using a first related art photo mask;

FIG. 6C is a schematic magnified cross-sectional view of a portion “B” of FIG 6B;

FIG. 7A is a schematic plan view of a second related art photo mask;

FIG. 7B is a schematic cross-sectional view of an organic layer formed by using a second related art photo mask;

FIG. 7C is a schematic magnified cross-sectional view of a portion “C” of FIG. 7B;

FIG. 8A is a graph showing an intensity profile of light transmitted through a single slit showing the different intensities using a wide slit and a narrow slit;

FIG. 8B is a schematic cross-sectional view showing photosensitive insulating layers after exposing and developing according to light transmitted through a wide single slit and a narrow single slit, respectively;

FIG. 8C is a graph showing intensity profiles of light transmitted through a double slit and a narrow single slit;

FIG. 8D is a schematic cross-sectional view showing photosensitive insulating layers after exposing and developing according to light transmitted through a double slit and a narrow single slit, respectively;

FIG. 9A is a schematic plan view of a photo mask according to a first embodiment of the present invention;

FIG. 9B is a schematic cross-sectional view of an organic layer formed by using a photo mask according to a first embodiment of the present invention;

FIG. 9C is a schematic magnified cross-sectional view of a portion “D” of FIG. 9B;

FIGS. 10A to 10F are schematic cross-sectional views showing a fabricating method of a reflective plate according to a second embodiment of the present invention; and

FIG. 11 is a schematic cross-sectional view of a reflective liquid crystal display device according to the present invention.

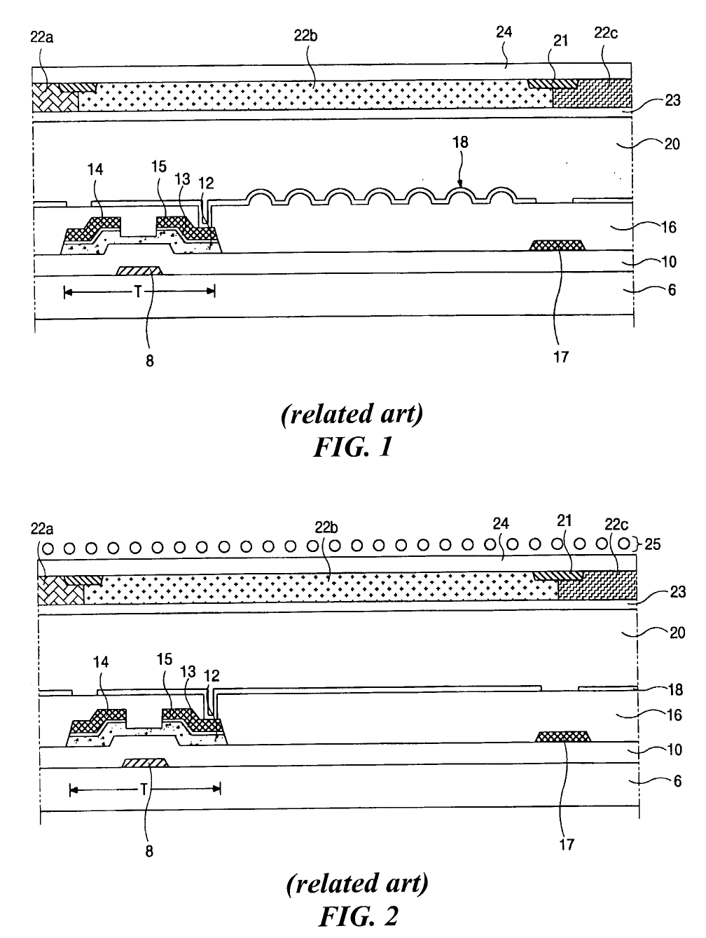

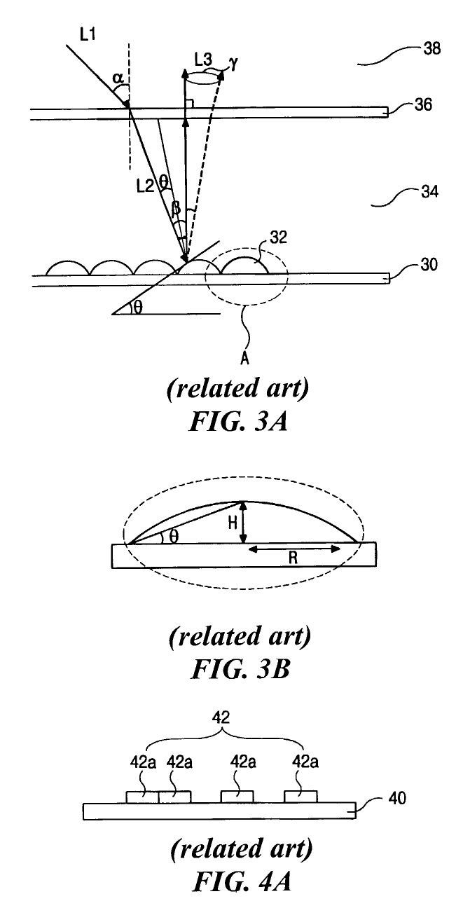

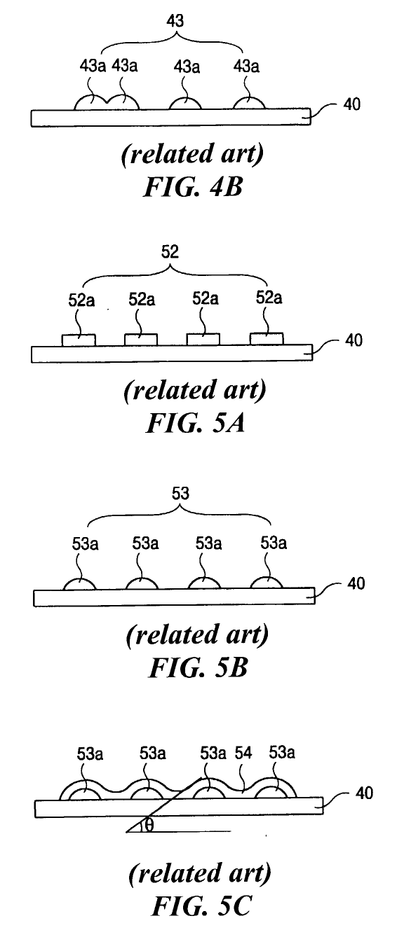

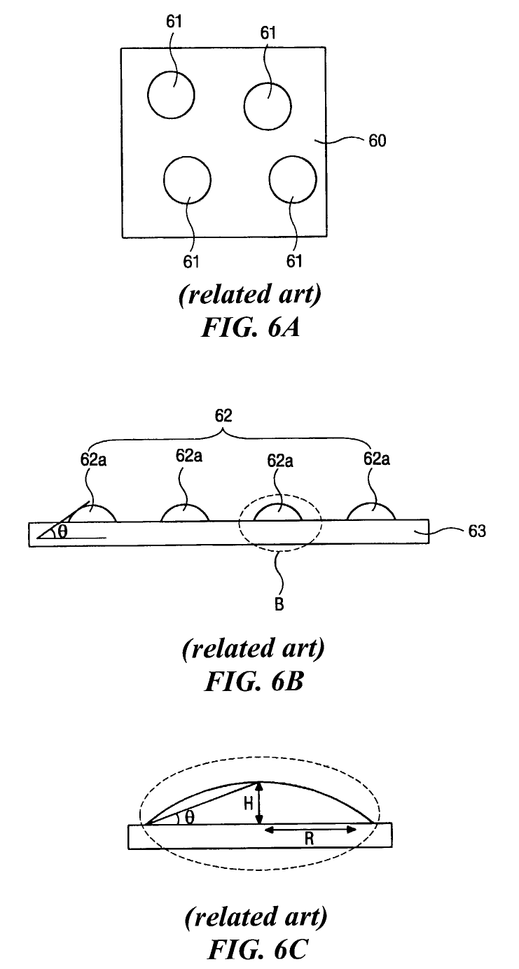

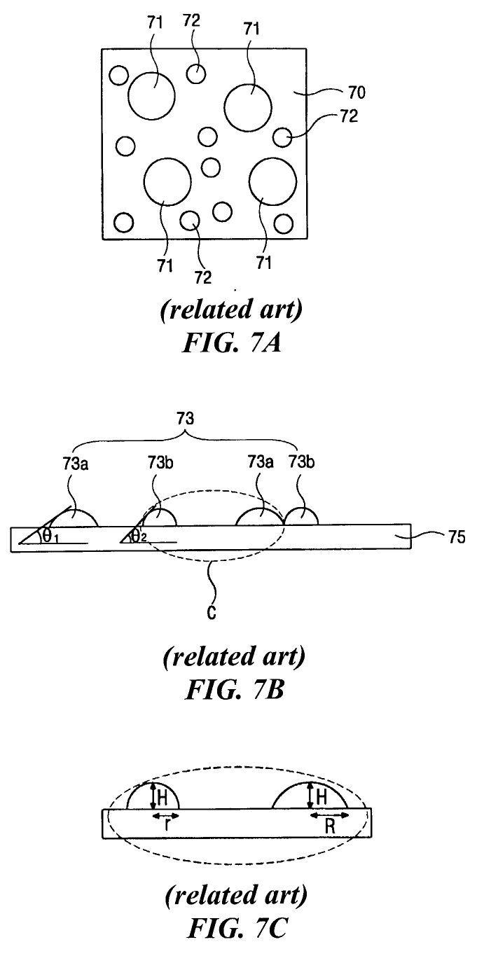

### DETAILED DESCRIPTION OF THE ILLUSTRATED EMBODIMENTS

Reference will now be made in detail to an embodiment of the present invention, example of which is illustrated in the accompanying drawings. Wherever possible, similar reference numbers will be used throughout the drawings to refer to the same or like parts.

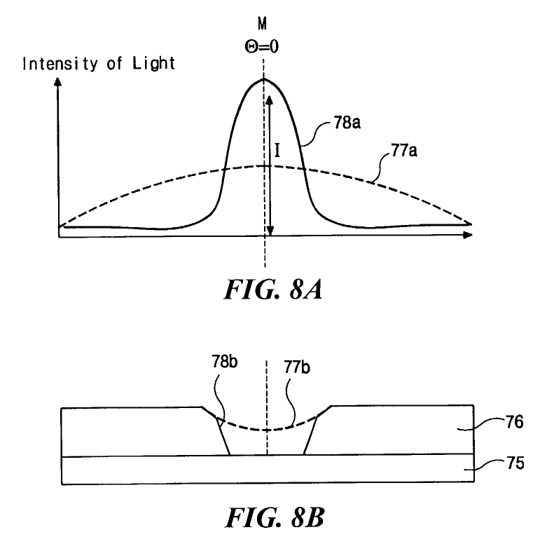

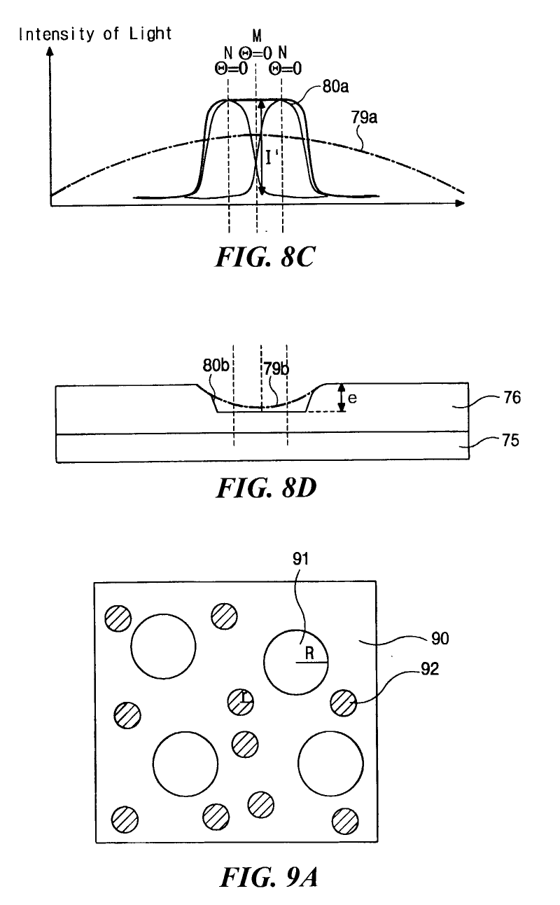

FIG. 8A is a graph showing an intensity profile of light transmitted through a single slit showing the different intensities using a wide slit and a narrow slit.

FIG. 8B is a schematic cross-sectional view showing photosensitive insulating layers after exposing and developing according to light transmitted through a wide single slit and a narrow single slit, respectively.

In FIGS. 8A and 8B, a Fraunhofer's diffraction where both an incident wave and a diffractive wave are plane waves is shown. An intensity distribution of light reaching an organic layer 76 on a substrate 75 through a single slit has a Gaussian shape and the highest intensity (I) occurs at a center of the single slit. A full width half maximum (FWHM) is proportional to a wavelength (λ) of light and inversely proportional to a width of the single slit. Accordingly, for a case of a wide single slit, the intensity distribution 78a at the center is high and has a narrow width and the exposed portion 78b of the organic layer 76 including a photo curable resin is fully removed due to exposure of light having a high energy. On the other hand, for a case of narrow single slit, the intensity distribution 77a at the center is low and has a wide width and the exposed portion 77b of the organic layer 76 including a photo curable resin remains due to exposure of low energy.

Equation (1) shows a relationship between a diffraction angle with respect to a propagation direction, an intensity, a wavelength and a width of a single slit.

I=I₀(sin β/β)² (1)

where β=½kb sin θ (2)

and in equation (1) when the intensity of light is at its lowest peak, β=π

therefore, sin θ=2π/kb=λ/b.

Here I is an intensity of light, k is a propagation constant, λ is a wavelength of light, b is a width of a single slit, and θ is a diffraction angle with respect to a propagation direction.

As shown in the equation (1), an optical resolution may be obtained by reducing the FWHM of the intensity distribution curve resulting from a low diffraction angle Θ.

In the single slit device, an amount of light emitted may be adjusted by varying a width of the single slit. In a double slit device, an amount of light emitted may be adjusted by forming the double slit to have different diffraction angles.

FIG. 8C is a graph showing intensity profiles of light transmitted through a double slit and a narrow single slit.

FIG. 8D is a schematic cross-sectional view showing photosensitive insulating layers after exposing and developing according to light transmitted through a double slit and a narrow single slit, respectively.

In FIGS. 8C and 8D, there are two positions “N” where a diffraction angle θ is 0 in the case of a double slit. An intensity distribution of each position “N” of light reaching an organic layer 76 on a substrate 75 through the double slit has two intensity profiles and these two intensity profiles are superimposed. As a result, light transmitted through the double slit has a maximum intensity “I′” higher according to a combined superposition than the maximum intensity “I” of the narrow single slit profile. For a case of a double slit, the combined intensity distribution 80a is high and has a narrow width and the exposed portion 80b of the organic layer 76 including a photo curable resin is formed to have a step “e” with one exposure process. The intensity distribution 79a of a narrow single slit is low and has a wide width and the exposed portion 79b of the organic layer 76 including a photo curable resin is formed in a round shape.

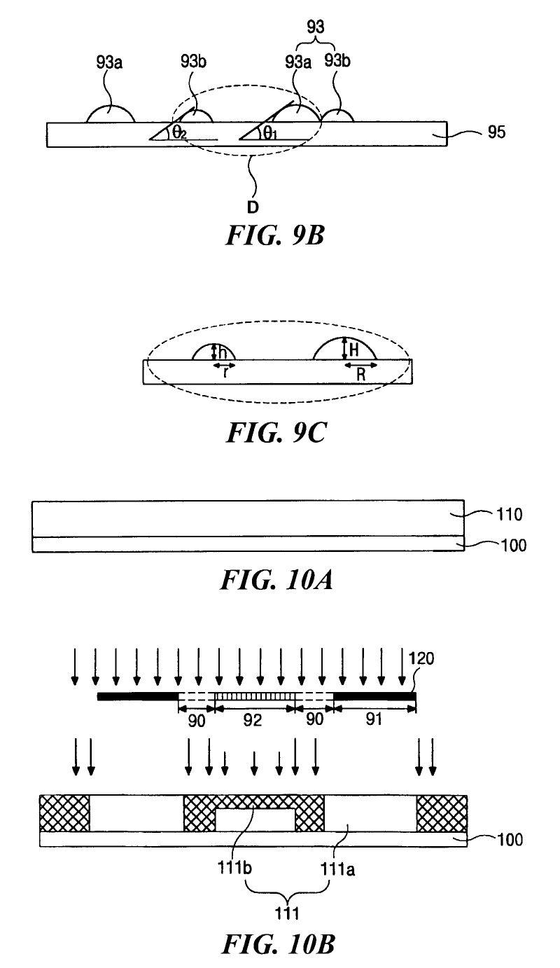

FIG. 9A is a schematic plan view of a photo mask according to a first embodiment of the present invention.

In FIG. 9A, a photo mask according to a first embodiment of the present invention includes a transmissive portion 90, a shielding portion 91 and a half-transmissive portion 92. A radius “R” of the shielding portion 91 is longer than that “r” of the half-transmissive portion 92 (R>r). The shielding portion 91 and the half-transmissive portion 92 are randomly disposed. Further, the half-transmissive portion 92 has a plurality of slits. The half-transmissive portion 92 may be made using a gray mask, a half-tone masking, and a diffraction mask.

FIG. 9B is a schematic cross-sectional view of an organic layer formed by using a photo mask according to a first embodiment of the present invention. FIG. 9C is a schematic magnified cross-sectional view of a portion “D” of FIG. 9B.

In FIGS. 9B and 9C, the organic layer 93 includes a photo-curable resin. The photo-curable resin is classified into positive and negative types. In the positive type, a portion exposed to light is removed during a later development process. In the negative type, a portion exposed to light remains during a later development process. Even though both these two types may be applied to the embodiment of the present invention, the positive type is adopted to form the organic layer.

The organic layer 93 includes first and second organic patterns 93a and 93b corresponding to the shielding portion 91 and the half-transmissive portion 92, respectively. The height of first organic pattern 93a is higher than the second organic pattern 93b (H>h). After patterning the organic layer 93, the organic layer 93 is melted by heat treatment. Even though the first and second organic patterns 93a and 93b have different radii and heights, a ratio of the radius “R” or “r” to the height “H” or “h” has a range of values. That is, a ratio of the radius “R” to the height “H” of the first organic pattern 93a is the same as a ratio of the radius “r” to the height “h” of the second organic pattern 93b (H/R=h/r). The ratio of each organic pattern is within a range of about 0.1 to about 0.2. Therefore, a first slanting angle “θ₁” of the first organic pattern 93a and a second slanting angle “θ₂” of the second organic pattern 93b (θ₁=θ₂) have a value proportional to the above range of values. The slanting angle of each organic pattern with respect to the substrate is within a range of about 6° to about 10°. Accordingly, all light reflected at the first and second organic patterns 93a and 93b propagate along the direction according to the above values for the range of the slanting angle within a main viewing angle.

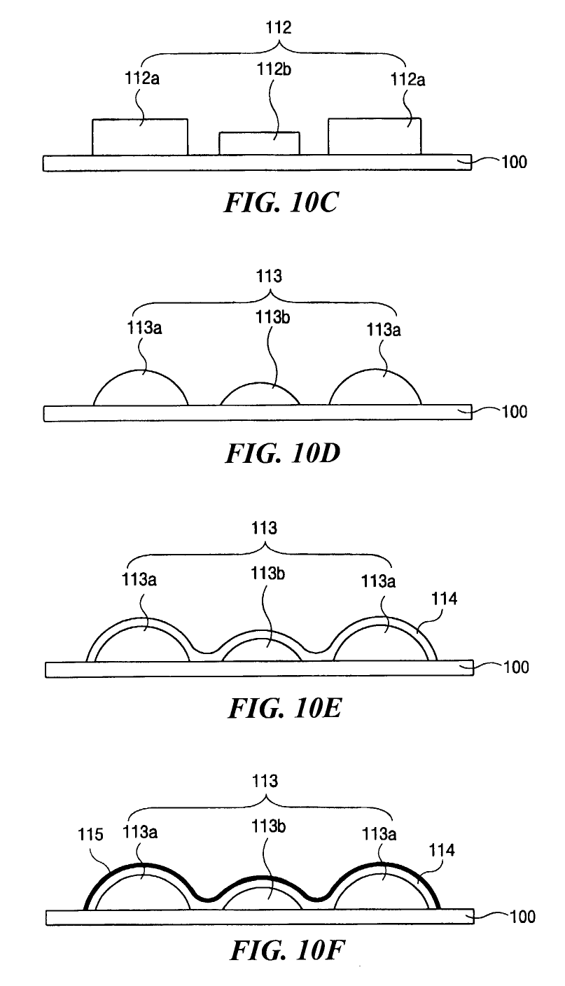

FIGS. 10A to 10F are schematic cross-sectional views showing a fabricating method of a reflective plate according to a second embodiment of the present invention.

In FIG. 10A, a first organic layer 110 of a positive type photo curable resin is deposited on a substrate 100.

In FIG. 10B, a photo mask 120 includes a transmissive portion 90, a shielding portion 91 and a half-transmissive portion 92 made using multiple slits as shown in FIG. 9A. Since light is diffracted at the half-transmissive portion 92, a first portion 111a of the first organic layer 111 is fully exposed and a second portion 111b of the first organic layer 111 is partially exposed at the same time with one photo mask 120.

In FIG. 10C, after a development process, the first organic layer 112 includes first and second organic patterns 112a and 112b corresponding to the shielding portion 91 and the half-transmissive portion 92, respectively. Since the first and second organic patterns 112a and 112b are exposed to different amounts of light, the first and second organic patterns 112a and 112b have different heights and radii from each other.

In FIG. 10D, the first and second organic patterns 113a and 113b are melted by a heat treatment of about 100° C. to 200° C. and a surface of each organic pattern becomes round. Next, the first and second organic patterns 113a and 113b are hardened by a curing process.

In FIG. 10E, a second organic layer 114 including benzocyclobutence (BCB) or acrylic resin is formed on the first and second organic patterns 113a and 113b by a method such as spin coating. When the second organic layer 114 is coated, an effective slanting angle is obtained by adjusting a thickness of the second organic layer 114.

In FIG. 10F, a reflective plate 115 is formed on the second organic layer 114 through depositing an opaque metallic material such as aluminum (Al), aluminum alloy, or silver (Ag).

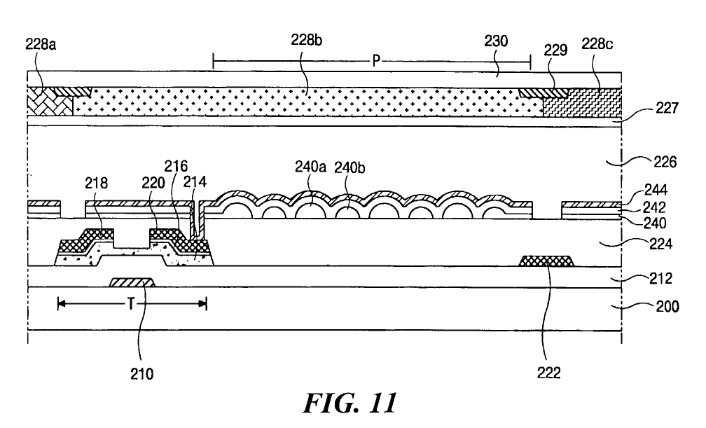

FIG. 11 is a schematic cross-sectional view of a reflective liquid crystal display device according to the present invention.

In FIG. 11, upper and lower substrates 230 and 200 are spaced apart and a liquid crystal layer 226 is interposed therebetween. A black matrix 229, a color filter layer 228a, 228b and 228c, and a common electrode 227 are sequentially formed on an inner surface of the upper substrate 230. A gate line (not shown) and a data line 222 defining a pixel region “P” are formed on an inner surface of the lower substrate 200. A thin film transistor (TFT) “T” including a gate electrode 210, gate insulating layer 212, an active layer 214, and source and drain electrodes 218 and 220 are connected to the gate line and the data line 222. A passivation layer 224 is formed on the TFT “T” and the data line 222. A first organic layer 240 including first and second organic patterns 240a and 240b at the pixel region “P” is formed on the passivation layer 224. A second organic layer 242 and a reflective plate 244 are sequentially formed on the first organic layer 240. Here, the first and second organic patterns 240a and 240b may have an uneven shape of different height and radius through the process of FIGS. 10A to 10D. Moreover, a thickness of the second organic layer 242 is adjusted to obtain an effective slanting angle. The first and second organic layers 240 and 242, and the reflective plate 244 are formed to increase a scattering area and a brightness of a reflective liquid crystal display device that does not use an artificial light source. Further, the reflective plate may be connected to the drain electrode 220 of the TFT “T.”

Consequently, an array substrate for a reflective liquid crystal display device according to the present invention and a fabricating method thereof have several advantages.

Since a first organic layer is formed to have first and second organic patterns of different height and radius, a scattering area increases and a brightness is improved.

Further, a repeatability of an effective slanting angle is obtained by forming a second organic layer on a first organic layer.

Moreover, since a first organic layer having first and second organic patterns of different height and radius is formed by one exposure process using a half-transmissive photo mask, a fabricating process is simplified and a production yield increases.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An array substrate for a reflective liquid crystal display device, comprising:
a substrate;
a first organic layer on the substrate, the first organic layer having a plurality of organic patterns of uneven shape, the plurality of organic patterns having at least two heights and at least two radii, a ratio of the height to the radius of each organic pattern having a range of values to collimate to the direction of the main viewing angle; and
a reflective plate on the first organic layer, the reflective plate having a high reflectance.

2. The substrate according to claim 1, further comprising a second organic layer on the first organic layer.

3. The substrate according to claim 2, wherein the second organic layer has one of an organic material group including benzocyclobutene (BCB) and acrylic resin.

4. The substrate according to claim 1, further comprising a thin film transistor, a gate line and a data line on the substrate.

5. The substrate according to claim 4, wherein the reflective plate is electrically connected to the thin film transistor.

6. The substrate according to claim 1, wherein the ratio of the height to the radius of each organic pattern is within a range of about 0.1 to about 0.2.

7. The substrate according to claim 1, wherein a slanting angle of each organic pattern with respect to the substrate is within a range of about 6° to about 10°.

8. The substrate according to claim 1, wherein the first organic layer includes a photo curable resin.

9. The substrate according to claim 1, wherein the reflective plate has one of a conductive metal group including aluminum (Al), aluminum alloy and silver (Ag).

10. A fabricating method of an array substrate for a reflective liquid crystal display device, comprising:
forming a first organic layer on a substrate, the first organic layer having a plurality of organic patterns of uneven shape, the plurality of organic patterns having at least two heights and at least two radii, a ratio of the height to the radius of each organic pattern having a range of values to collimate to the direction of the main viewing angle; and
forming a reflective plate on the first organic layer, the reflective plate having a high reflectance.

11. The method according to claim 10, further comprising heating the first organic layer.

12. The method according to claim 10, further comprising forming a thin film transistor, a gate line and a data line on the substrate.

13. The method according to claim 10, further comprising a second organic layer on the first organic layer.

14. The method according to claim 10, wherein forming the first organic layer is performed by using a photo mask having a transmissive portion, a half-transmissive portion and a shielding portion.

15. The method according to claim 10, wherein heating the first organic layer is performed within a temperature range of about 100° C. to 200° C.

16. The method according to claim 10, wherein the second organic layer is formed by spin coating.

17. The method according to claim 10, wherein the second organic layer has one of an organic material group including benzocyclobutene (BCB) and acrylic resin.

18. The method according to claim 10, wherein the ratio of the height to the radius of each organic pattern is within a range of about 0.1 to about 0.2.

19. The method according to claim 10, wherein a slanting angle of each organic pattern with respect to the substrate is within a range of about 6° to about 10°.

20. The method according to claim 10, wherein the first organic layer includes a photo curable resin.

21. The method according to claim 10, wherein the reflective plate has one of a conductive metal group including aluminum (Al), aluminum alloy and silver (Ag).

22. The method according to claim 14, the half-transmissive portion is made using one of a gray mask, a half tone mask, and a diffraction mask.
